(19) United States
(12) Patent Application Publication
(10) Pub. No.: US 2013/0193929 A1
(43) Pub. Date: Aug. 1, 2013

(54) Battery with at least two electrochemical energy converters and method of operating said battery

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 13/743,682

(22) Filed: Jan. 17, 2013

Related U.S. Application Data
(60) Provisional application No. 61/615,916, filed on Mar. 27, 2012.
(60) Provisional application No. 61/587,708, filed on Jan. 18, 2012.

(30) Foreign Application Priority Data
Jan. 18, 2012 (DE) DE 102012000872.4
Mar. 27, 2012 (DE) DE 102012006202.8

(51) Int. Cl. H02J 7/00; H01M 10/42; H01M 2/20

(52) U.S. Cl. CPC H02J 7/0029; H01M 2/20; H01M 10/4207
USPC 320/136; 429/121

(57) ABSTRACT

A battery with a converter including at least two electrochemical energy converters provided to convert chemical energy into electrical energy and to supply electrical energy particularly to a consumer has the energy converters electrically connected to one another. The converter arrangement includes two configuration connectors of different polarity at which a configuration voltage is present, and the configuration voltage corresponds to the electrical voltage of the converter. Two battery connectors of different polarity are also included and make the electrical connection to the consumer. The battery connectors are electrically connected to the configuration connectors The battery also includes a device connected at least indirectly to the configuration connectors which can be converted from a first state into a second state. In the first state, the configuration connectors are electrically insulated from one another and in the second state they are electrically connected to one another.

The present invention relates to a battery with at least two electrochemical energy converters and a method of operating said battery. The invention is described in connection with lithium-ion batteries for supplying motor vehicle drives. It should be noted that the invention can also be used independently of the battery design, the chemistry of the electrochemical energy converters or independently of the nature of the drive supplied.

Batteries with a plurality of electrochemical energy converters for supplying motor vehicle drives are known in the art. The electrochemical energy converters are usually electrically connected to one another, particularly to increase the battery voltage, battery capacity or the range of the motor vehicle supplied by the battery.

Operating reliability is particularly important in the case of batteries of this kind, particularly when they are used in motor vehicles, but not only in these cases.

The problem addressed by the invention is therefore that of providing batteries with greater operating reliability.

The problem is solved by a battery according to claim 1. The problem is also solved by an operating method according to claim 8 for a battery. Preferable developments of the invention are the subject matter of the dependent claims.

A battery according to the invention exhibits a converter configuration having at least two or a plurality of electrochemical energy converters. This converter configuration is provided to convert chemical energy into electrical energy at least temporarily and to supply electrical energy particularly to a consumer at least temporarily. Within this converter arrangement, at least two of these energy converters are electrically connected to one another, particularly series-connected. The converter arrangement exhibits two configuration connectors of different polarity. The configuration voltage exhibits two configuration connectors of different polarity. The configuration voltage is present at these configuration connectors, wherein the configuration voltage corresponds to the electrical voltage of the converter configuration or the interconnected energy converters.

The battery exhibits two battery connectors of different polarity, which are provided to make the electrical connection to the consumer. The battery connectors are electrically connected to the configuration connectors at least temporarily. The configuration voltage is then present at the battery connectors.

The battery exhibits at least one or a plurality of functional devices. At least one of these functional devices is provided to be connected at least indirectly to these configuration connectors of different polarity. At least one or a plurality of these functional devices is provided to be converted from a first state into a second state. In the first state, the configuration connectors of different polarity connected to the functional device are electrically insulated from one another. In the second state, the configuration connectors of different polarity connected to the functional device are electrically connected to one another.

Preferably the functional device exhibits a predetermined electrical resistance [Ω], particularly in the second state. The electrical resistance is preferably at least 0.5Ω, further preferably at least 1Ω, further preferably at least 2Ω, further preferably at least 5Ω, further preferably at least 10Ω, further preferably at least 20Ω, further preferably at least 50Ω, further preferably at least 100Ω, further preferably at least 200Ω, further preferably at least 500Ω, further preferably at least 1000Ω. This embodiment offers the advantage that a discharge current, which can be drawn from the converter configuration in the second state of the functional device, can be limited by the functional device. The electrical heat output is therefore also limitable. Particularly preferably, the electrical resistance is adjusted to the electrical voltage of the converter configuration in such a manner that the heat output in the resistor is limited in the second state to a maximum of 500 W, further preferably to a maximum of 200 W, further preferably to a maximum of 100 W, further preferably to a maximum of 50 W, further preferably to a maximum of 20 W, further preferably to a maximum of 10 W, further preferably to a maximum of 5 W, further preferably to a maximum of 2 W, further preferably to a maximum of 1 W. Consequently, a discharge current which flows through the functional device in the second state only causes a limited heat output. This embodiment offers the advantage that accelerated thermal aging of the converter configuration or one of its energy converters is counteracted.

Preferably the converter configuration exhibits at least one wall section, which is provided to delimit the converter configuration, particularly with respect to the surroundings thereof. Particularly preferably, the at least one wall section is part of a housing of one of these energy converters or part of a housing surrounding the converter configuration. The functional device covers this wall section at least in areas. Particularly preferably, the functional device covers this wall section substantially completely. This preferred embodiment offers the advantage that the operating reliability of the converter configuration is improved independently of the place at which the foreign body acts. The functional device is particularly preferably disposed adjacent to this wall section.

Preferably at least one or a plurality of these energy converters, particularly preferably all of these energy converters, is configured as an electrochemical energy store. An electrochemical energy store within the meaning of the invention should be understood to mean a device which is particularly used to convert supplied electrical energy into chemical energy and store it at least temporarily. Furthermore, this energy store is designed to convert stored chemical energy into electrical energy before the provision of electrical energy. This preferred embodiment offers the advantage of a simplified design, in that the supply of a combustible process fluid can be dispensed with.

If a foreign body acts on the battery according to the invention, particularly on at least one of these electrochemical energy converters of the battery according to the invention, or penetrates said battery, for example during an accident, particularly one involving a motor vehicle, the energy converter may be damaged. It has been observed that a battery releases energy into the environment unchecked, particularly following damage particularly to one of its energy converters. The battery according to the invention offers the advantage that the functional device limits or controls the energy release from the damaged battery or from the damaged energy converter in the second state by means of its electrical resistor. The battery according to the invention offers the advantage that the checked energy release from the converter configuration is made possible even if only one of these functional devices is damaged by the foreign body. The battery according to the invention offers the advantage that the parallel-connected functional device which is electrically conductive in the second state is used as a second current path to reduce the energy stored in the battery or the converter configuration, particularly when the foreign body has penetrated both the functional device and also the converter device, particularly if the foreign body has deformed the functional device. The energy stored in this converter configuration is therefore reduced, the operating reliability of the converter configuration and with it the operating reliability of the primary battery is increased and the underlying problem is therefore solved.

An electrochemical energy converter within the meaning of the invention should be understood to be a device which is particularly used to convert chemical energy into electrical energy, at least temporarily, and to supply electrical energy particularly to a consumer, at least temporarily. The electrochemical energy converter exhibits an electrode subassembly for this purpose. An electrode subassembly within the meaning of the invention should be understood to mean a device which is particularly used to supply electrical energy. The electrode subassembly exhibits at least two electrodes of different polarity. These electrodes of different polarity are spaced apart by a separator, said separator being conductive for ions but not for electrons. The electrode subassembly is preferably substantially cuboid in design. The electrode subassembly is preferably positively connected to two of these current-conducting devices of different polarity, said current-conducting devices serving to make the electrical connection to at least one adjacent electrode subassembly and/or at least indirectly the electrical connection to the consumer.

At least one of these electrodes preferably exhibits a particularly metallic collector film and also an active material. The active material is applied to at least one side of the collector film. During the charging or discharging of the electrode subassembly, electrons are exchanged between the collector film and the active material. At least one conductor lug is preferably connected to the collector film, particularly with a positive connection. Particularly preferably, a plurality of conductor lugs is positively connected to the collector film. This embodiment offers the advantage that the current for each conductor lug is reduced.

At least one of these electrodes preferably exhibits a particularly metallic collector film and two active materials of different polarity, which are disposed on different areas of the collector film and are spaced apart by the collector film. The term “bi-cell” is also customary for this configuration of active materials. During the charging or discharging of the electrode subassembly, electrons are exchanged between the collector film and the active material. At least one conductor lug is preferably connected to the collector film, particularly positively connected. Particularly preferably, a plurality of conductor lugs is connected to the collector film, particularly positively connected. This embodiment offers the advantage that the number of electrons which flow through a conductor lug per unit of time is reduced.

Two electrodes of different polarity are spaced apart by a separator in the electrode subassembly. The separator is permeable to ions but not to electrons. The separator preferably contains at least part of the electrolyte or of the conducting salt. The electrolyte is preferably configured substantially without a liquid portion, particularly following the closure of the energy converter. The conducting salt preferably exhibits lithium ions. Particularly preferably, lithium ions are deposited or intercalated in the negative electrode during charging and released again during discharging.

The electrode subassembly is preferably designed to convert supplied electrical energy into chemical energy and to store it as chemical energy. The electrode subassembly is preferably designed to convert particularly stored chemical energy into electrical energy, before the electrode subassembly makes this electrical energy available to a consumer. This is then referred to as a rechargeable electrode subassembly. Particularly preferably, lithium ions are deposited or intercalated in the negative electrode during charging and released again during discharging.

According to a first preferred embodiment, the electrode subassembly is configured as an electrode coil, particularly as a substantially cylindrical electrode coil. This electrode subassembly is preferably rechargeable. This embodiment offers the advantage of easier producibility, particularly in that strip-shaped electrodes can be manipulated. This embodiment offers the advantage that the charging capacity of the electrode subassembly, given in ampere-hours [Ah] or watt-hours [Wh], less commonly in coulombs [C], for example, can be easily increased by means of additional coils. The electrode subassembly is preferably configured as a flat electrode coil. This embodiment offers the advantage that said coil can be arranged in a space-saving manner alongside a further flat electrode coil, particularly within a battery.

According to a further preferred embodiment, the electrode subassembly is configured as a substantially cuboid electrode stack. This electrode subassembly is preferably rechargeable. The electrode stack exhibits a predetermined sequence of stack sheets, wherein two electrode sheets of different polarity in each case are separated by a separator sheet. Each electrode sheet is preferably connected to a current-conducting device, particularly positively connected, particularly preferably formed integrally with the current-conducting device. Electrode sheets of the same polarity are preferably electrically connected to one another via a common current-conducting device. This embodiment of the electrode subassembly offers the advantage that the charging capacity of the electrode subassembly, indicated in ampere-hours [Ah] or watt-hours [Wh], less commonly in coulombs [C], for example, can easily be increased through the addition of further electrode sheets. Particularly preferably, at least two separator sheets are connected to one another and enclose a limiting edge of an electrode sheet. An electrode subassembly of this kind with an individual, particularly a meandering, separator is described in WO 2011/020545. This embodiment offers the advantage that a parasitic current emanating from this limiting edge to an electrode sheet with a different polarity is thwarted.

According to a third preferred embodiment, the electrode subassembly is configured as a converter subassembly. The converter subassembly may supply electrical energy by taking in two continuously supplied process fluids, the chemical reaction of said fluids leading to a reactant, particularly supported by at least one catalyst, and release of the reactant. A process fluid should be taken to mean a combustible and an oxidant, in particular. The converter subassembly is configured as a substantially cuboid electrode stack and exhibits at least two particularly sheet-shaped electrodes of different polarity. The first electrode at least is preferably coated with a catalyst at least in areas. The electrodes are spaced apart, preferably by a separator or a membrane, which contains an electrolyte and which is permeable to ions but not to electrons. Furthermore, the energy converter exhibits two fluid-guiding devices, which are each disposed and arranged adjacent to the electrodes of different polarity and are provided to supply the electrodes with process fluids. The energy converter exhibits at least one of the sequences: fluid-guiding device for the first process fluid—electrode of first polarity—membrane—electrode of second polarity—fluid-guiding device for the second process fluid. A plurality of these sequences is preferably connected in series for increased electrical voltage. During operation of the energy converter, the first process fluid is supplied to the first electrode, particularly as a fluid stream through channels in the first fluid-guiding device. The first process fluid is ionised at the first electrode, thereby releasing electrons. The electrons are removed via the electrode, particularly via one of the current-conducting devices, particularly in the direction of an electrical consumer or an adjacent energy converter. The ionised first process fluid migrates through the ion-permeable membrane to the second electrode. The second of these process fluids is supplied to the second electrode, particularly as a fluid stream through channels in the second fluid-conducting device. The following converge at the second electrode: the second process fluid, the ionised first process fluid and electrons from the electrical consumer or an adjacent energy converter. A chemical reaction takes place at the second electrode producing the reactant, which is preferably removed through channels in the second fluid-guiding device.

A converter configuration within the meaning of the invention should be taken to mean a device which is particularly used to convert chemical energy into electrical energy at least temporarily and to supply electrical energy particularly to a consumer at least temporarily. The converter configuration exhibits at least two electrochemical energy converters, wherein the energy converters are electrically connected to one another, particularly in series. The converter configuration exhibits at least four energy converters, particularly in series connection. The converter configuration preferably exhibits a series connection of a number of energy converters such that a voltage of the converter configuration of at least 12 V, further preferably of at least 24 V, further preferably of at least 36 V, further preferably of at least 48 V, further preferably of at least 60 V, further preferably of at least 72 V, further preferably of at least 84 V, further preferably of at least 96 V results. This preferred embodiment offers the advantage that the supply of an electric motor, particularly of a supplied motor vehicle, with a higher voltage and, where there is a lower current intensity, with incoming lines of smaller cross-section and lower weight, is made possible.

The converter configuration exhibits two configuration connectors of different polarity. The configuration voltage is present at these configuration connectors, wherein the configuration voltage corresponds to the electrical voltage of the converter configuration or the interconnected energy converter. The configuration connectors for the electrical connection to incoming lines are preferably designed as terminals, as rotationally symmetrical projections or as particularly weldable surfaces. The configuration connectors are connectable to the battery connectors. The configuration connectors are preferably at least temporarily connected to the battery connectors. The configuration voltage is then also present at the battery connectors.

The converter configuration preferably exhibits a plurality of storage groups, wherein one storage group comprises a plurality of interconnected energy converters. In one storage group, a plurality of these energy converters is electrically connected to one another, preferably in series, wherein the voltage of the storage group, particularly the terminal voltage thereof, is at least temporarily at least 12 V, further preferably at least 24 V, further preferably at least 36 V, further preferably at least 48 V, further preferably at least 60 V, further preferably at least 72 V, further preferably at least 84 V, further preferably at least 96 V. This preferred embodiment offers the advantage that the supply of an electric motor, particularly of a supplied motor vehicle, with a higher voltage and, where there is a lower current intensity, with incoming lines of a smaller cross-section and lower weight, is possible.

According to a preferred embodiment of the converter configuration, a plurality of storage groups is connected to one another in series for a greater configuration voltage and/or is connected to one another in parallel for a greater electrical current of the converter configuration. Particularly preferably, a plurality of storage groups is designed with one another, such that the configuration voltage is at least 400 V. This preferred converter configuration exhibits two of these configuration connectors. This embodiment offers the advantage of improved driving performance of a supplied motor vehicle.

A battery connector within the meaning of the invention should be taken to mean a device which is particularly used to be connected at least temporarily to one of the configuration connectors. The battery connector then exhibits one of the electrical potentials of the configuration voltage. The battery connector for the particularly positive connection to incoming electrical lines is preferably designed as terminals, as rotationally symmetrical projections or with surfaces. Two of these battery connectors are preferably electrically connected at least temporarily to one of these configuration connectors of different polarity in each case. Contact can preferably be made with these battery connectors from the surroundings of the battery.

A functional device within the meaning of the invention should be taken to mean a device which is particularly provided to be connected at least indirectly to these configuration connectors of different polarity. The functional device is provided to be converted into a second state, wherein the configuration connectors of different polarity are electrically connected to one another in the second state of the functional device. For this purpose, the configuration connectors of different polarity are electrically connected to the functional device. In a first state of the functional device, the configuration connectors of different polarity are electrically insulated from one another. The functional device is designed in such a way that the foreign body not associated with the battery, which acts on the battery from the surroundings, is able to convert the functional device into its second state. The foreign body initiates the conversion of the functional device into its second state particularly through:
a force, which the foreign body exerts on the battery or on the converter configuration, particularly on the wall section thereof, or
damage to the functional device caused by the foreign body or
penetration of the functional device by the foreign body.

The functional device is preferably designed to cover at least one or a plurality of wall sections of the converter configuration substantially completely. This embodiment offers the advantage that the functional device improves the protection of the converter configuration, independently of the location of the effect of the foreign body on the functional device or on the converter configuration.

The wall thickness of the functional device is preferably less than ⅕ of the thickness of one of these energy converters. This embodiment offers the advantage that the gravimetric energy density [Wh/kg] of the converter configuration is only marginally reduced by the functional device.

Preferred embodiments or developments of the invention are described below.

The battery preferably exhibits at least two of these functional devices, which particularly preferably cover opposite wall sections of the converter configuration substantially completely. This configuration offers the advantage that the functional devices improve the protection of the converter configuration independently of the location of the effect of the foreign body on the battery of the converter configuration thereof.

In a preferred embodiment, the functional device exhibits at least one or a plurality of first potential regions, at least one or a plurality of second potential regions and at least one or a plurality of insulating regions. At least one of these first potential regions is electrically insulated by one of these second potential regions by one of these insulating regions. A potential region within the meaning of the invention should be understood to mean a device which is electrically conductive and exhibits the electrical potential of one of the electrodes of the electrode assembly. Particularly preferably, one of these first potential regions and one of these second potential regions in each case are electrically insulated from one another by one of these insulating regions. At least one of these first potential regions is used to form an electrical connection with at least one of these first polarity electrodes. At least one of these second potential regions is used to form an electrical connection with at least one of these second polarity electrodes. Particularly preferably, all first polarity electrodes are electrically connected to at least one of these first potential regions and all second polarity electrodes are electrically connected to at least one of these second potential regions.

If a foreign body penetrates the functional device and in so doing damages the insulating region, the potential regions of different polarity adjacent to the insulating region then come into electrical contact. A current path is closed, which electrically connects to one another indirectly, i.e. via the potential regions of different polarity, at least two of these electrodes of different polarity. Via this current path, electrical energy or a discharge current may be drawn from the converter configuration. The electrically conductive potential regions R_{P1}, R_{P2} and, in particular, the electrical contact resistance R_{K} between these potential regions of different polarity form anaggregate resistance R_{G}. This aggregate resistance R_{G} acts against the discharge current. In this case, the contact resistance R_{K} may be considerably greater than the resistances of the potential regions R_{P1}, R_{P2}. If the contact resistance R_{K} accounts for the largest proportion of the aggregate resistance R_{G}, then the electrical energy drawn from the converter configuration is converted into thermal energy there for the most part. In this case, the electrically and also thermally conductive potential regions are used to distribute the thermal energy. This preferred embodiment offers the advantage of greater battery reliability during the operation thereof, particularly within a motor vehicle.

At least one of these insulating regions is preferably configured as an insulating layer on one of these potential regions. This preferred embodiment offers the advantage that the spatial requirement of the functional device is reduced still further.

The potential regions and the insulating regions are preferably surrounded by an electrically non-conductive pouch, particularly preferably by a polymer pouch. This embodiment offers the advantage that the functional device is electrically insulated in respect of a particularly metallic cell housing. The electrically non-conductive pouch preferably exhibits a woven fabric or a laid fabric of reinforcing fibres, particularly aramid fibres. This embodiment offers the advantage that a foreign body encounters greater mechanical resistance when penetrating the functional device.

In a preferred embodiment, at last one of these potential regions is designed as a puncture-resistant layer or is puncture-proof. For this purpose, this potential region exhibits
a woven fabric or a laid fabric of reinforcing fibres, particularly aramid fibres, and/or
at least one or a plurality of metal inserts, which are preferably connected to one another, and/or
at least one or a plurality of oxide-ceramic inserts, which are preferably designed in plate-form.

The preferred embodiment offers the advantage that this potential region offers up greater mechanical resistance to the foreign body, against the penetration thereof particularly into the converter configuration. Particularly preferably, the potential region which is disposed closer to the converter configuration is designed as a puncture-resistant layer or as puncture-proof. This preferred embodiment offers the advantage that the mechanical protection of the converter configuration does not impede either the conversion of the functional device into the second state or the protective action of the functional device.

In a preferred embodiment, at least one of these potential regions exhibits at least one or a plurality of electrical conductors or strip conductors, as well as a carrier for these conductors or strip conductors. These electrical conductors preferably comprise aluminium and/or copper. This embodiment offers the advantage that the quantity or the weight of the potential range is reduced.

These electrical conductors or strip conductors preferably extend along an edge of the potential region having a predetermined cross-sectional area. The electrical resistance of the potential region can also be adjusted via the dimensions of the cross-sectional surface. The electrical conductors preferably exhibit a resistance of at least 0.1Ω in each case, particularly in that their cross sections are sized accordingly. The electrical conductors or strip conductors are preferably connected to one another electrically and connected to at least one of these electrodes. This preferred embodiment offers the advantage that the electrical resistance of the potential region or of the functional device is adjustable.

If a foreign body penetrates the functional device and in so doing damages the insulating region, then the potential regions with different polarity adjacent to the insulating region come into electrical contact. A current path is closed, which connects at least two of these electrodes of different polarity to one another electrically in an indirect fashion, i.e. via the potential regions. Electrical energy or an electrical current may be drawn from the converter configuration via this current path. The electrically conductive potential regions R_{P1}, R_{P2} and, in particular, the electrical contact resistance R_{K} between these potential regions of different polarity create an aggregate resistance R_{G}. This aggregate resistance R_{G} counteracts the charging current. The contact resistance R_{K} in this case may be significantly larger than the resistances of the potential regions R_{P1}, R_{P2}. If the contact resistance R_{K} accounts for the largest share of the aggregate resistance R_{G}, the electrical energy drawn from the converter configuration is for the most part converted into thermal energy there. In this case, the electrically and also thermally conductive potential regions are used to distribute the thermal energy. This preferred embodiment provides the advantage of greater battery reliability during the operation thereof, particularly within a motor vehicle.

In a preferred embodiment, this insulating region exhibits at least one or a plurality of recesses, which are used for the electrical contact between the first potential region and the second potential region. If the foreign body deforms this functional device, particularly the potential region facing the surroundings, an electrical contact between the first potential region and of the second potential region can be made through one of these recesses, even without the foreign body penetrating the functional device. In this case, at least one of these potential regions extends through this recess in the direction of these other potential regions. This embodiment offers the advantage that the functional device can be converted into the second state even without penetration by the foreign body, particularly with a mere deformation of the functional device. Particularly preferably, this insulating region exhibits an arrangement of recesses. This embodiment offers the advantage that the functional device improves the protection of the converter configuration, irrespective of the location where the foreign body acts on the secondary cell or on the cell housing thereof.

The functional device preferably exhibits a substance for reaction with hydrogen fluoride, particularly preferably calcium chloride. This embodiment offers the advantage that hydrogen fluoride can be bound within the cell housing.

A first preferred embodiment of this functional device exhibits a first potential region and a second potential region, which are preferably designed as metal films. The insulating region is designed as an insulating film, preferably as a polymer film or paper, and is disposed between the two potential regions. The electrodes of first polarity are electrically connected to the first potential region and the electrodes of second polarity are connected to the second potential region. The functional device is of such dimensions that at least one of these wall sections is substantially completely covered by the functional device. The potential regions and the insulating region are preferably surrounded by an electrically non-conductive pouch, particularly preferably by a polymer pouch. This embodiment offers the advantage that the functional device is electrically insulated in respect of a particularly metallic cell housing. This embodiment offers the advantage that the functional device only takes up a small amount of space in the cell housing. This embodiment offers the advantage that the functional device can be produced cost-effectively. The functional device is preferably of such dimensions that at least two or three of these walls sections of the converter configuration lying adjacent to one another are substantially completely covered. This embodiment offers the advantage that the functional devices improve the protection of the converter configuration largely independently of the location where the foreign body acts on the secondary cell or on the cell housing thereof.

A second preferred embodiment of the functional device substantially corresponds to the aforementioned preferred embodiment, wherein one of these potential regions which faces the converter configuration is designed as a puncture-resistant layer or is puncture-proof. Furthermore, this potential region exhibits a carrier, particularly a carrier layer, on which a plurality of electrical conductors is disposed facing the insulating region.

The plurality of electrical conductors each has a predetermined electrical resistance of at least 0.1Ω. This preferred embodiment offers the advantage that the functional device provides mechanical protection of the converter configuration. This preferred embodiment offers the advantage that the functional device limits the discharge current in the second state.

A third preferred embodiment of the functional device corresponds substantially to one of the aforementioned preferred embodiments, wherein at least one of these insulating regions exhibits at least one or a plurality of recesses. This embodiment offers the advantage that the functional device can be converted into the second state even without penetration by the foreign body, particularly with a mere deformation of the functional device.

A preferred development of the aforementioned preferred embodiments of the functional device exhibits a stack of first potential regions, second potential regions and insulating regions. The stack exhibits a plurality of sequential arrangements of one of these first potential regions, one of these insulating regions and one of these second potential regions. This preferred development offers the advantage that a plurality of insulating regions are damaged as the penetration depth of the foreign body increases and a plurality of current paths is formed, by means of which the heat output of the discharge current is distributed.

In a preferred embodiment, the battery exhibits a discharge resistor, which is particularly provided to convert electrical energy from the converter configuration into thermal energy. The discharge resistor is connected between one of these configuration connectors and one of these potential regions. The discharge resistor is preferably connected to one of these wall sections, particularly in a thermally conductive manner. This embodiment offers the advantage that a discharge current which can be drawn from the converter configuration in the second state of the functional device can be limited by the discharge resistor.

The discharge resistor preferably exhibits a predetermined electrical resistance [Ω], particularly in the second state. The electrical resistance is preferably at least 0.5Ω, further preferably at least 1Ω, further preferably at least 2Ω, further preferably at least 5Ω, further preferably at least 10Ω, further preferably at least 20Ω, further preferably at least 50Ω, further preferably at least 100Ω, further preferably at least 200Ω, further preferably at least 500Ω, further preferably at least 1000Ω. This embodiment offers the advantage that a discharge current, which can be drawn from the converter configuration in the second state of the functional device, can be limited by the discharge resistor. The electrical heat output is therefore also limitable. Particularly preferably, the discharge resistor is adapted to the electrical voltage of the converter configuration in such a manner that the heat output in the resistor in the second state is limited to a maximum of 500 W, further preferably to a maximum of 200 W, further preferably to a maximum of 100 W, further preferably to a maximum of 50 W, further preferably to a maximum of 20 W, further preferably to a maximum of 10 W, further preferably to a maximum of 5 W, further preferably to a maximum of 2 W, further preferably to a maximum of 1 W. Consequently, a discharge current which flows through the discharge resistor in the second state only causes a limited heat output. This embodiment offers the advantage that accelerated thermal ageing of the converter configuration or of one of its energy converters is counteracted.

In a preferred embodiment, the battery exhibits a circuit breaker, which is connected between one of these configuration connectors and one of these battery connectors, particularly of the same polarity. The circuit breaker is particularly used to insulate the converter configuration electrically in respect of the surroundings, particularly in the second state of the functional device. The circuit breaker is particularly used to break the electrical connection at least temporarily between one of these configuration connectors and one of these associated battery connectors, particularly of the same polarity, preferably in the second state of the functional device. The circuit breaker is particularly provided to be activated and to break the electrical connection between this configuration connector and the battery connector, particularly of the same polarity, while in the activated state. For this purpose, the circuit breaker is preferably switched between the configuration connector of first polarity and the battery connector of first polarity or between the configuration connector of second polarity and the battery connector of second polarity.

In accordance with a first preferred embodiment, the circuit breaker is designed as an activated switch. The circuit breaker is preferably designed with a semiconductor switch or with a relay, which is provided to open an associated switch. The circuit breaker is preferably activated by a battery control device. Particularly in the second state of the functional device, the activated switch is at least temporarily open. The activated switch may be closed again after a predetermined interval of time. This preferred embodiment offers the advantage that after the switch has closed, the electrical voltage of the converter configuration can be measured via the battery connectors.

In accordance with a further preferred embodiment, the circuit breaker is designed with a breaking unit particularly activated by the battery control device and with an electrical conductor. The electrical conductor is connected between this configuration connector and this battery connector. The breaking device is provided to act on the electrical conductors in such a way that the electrical conductivity thereof is largely, particularly substantially completely, lost. The breaking device is preferably designed to split the electrical conductor, so that the current path between the configuration connector and the battery connector is interrupted. The electrical voltage of the convertor configuration is no longer present at the battery connectors following entry into the second state. This preferred embodiment offers the advantage of greater battery reliability, particularly even following the harmful effects of a foreign body.

In a preferred embodiment, the battery exhibits at least one measuring sensor. This measuring sensor is provided to record an operating parameter of the battery, particularly of the converter configuration. The measuring sensor provides a signal, at least temporarily, particularly to the battery control device. The measuring sensor is preferably designed as: a voltage sensor, a current sensor, a temperature sensor or thermocouple, a pressure sensor, a substance sensor for a chemical substance, a gas sensor, a liquid sensor, a locational sensor or an acceleration sensor. Particularly preferably, the measuring sensor is designed as a temperature sensor or an acceleration sensor.

An operating parameter within the meaning of the invention should be understood to mean a parameter of the converter configuration in particular, which particularly
allows inferences to be drawn in relation to a desired operating state of the converter configuration and/or
allows inferences to be drawn in relation to anunplanned or unwanted operating state of the converter configuration and/or
can be determined by a measuring sensor, wherein the measuring sensor supplies a signal at least temporarily, preferably an electrical voltage or an electrical current, particularly of the converter configuration and/or
is processed by a control device, particularly a battery control device, is particularly associated with a target value, is particularly associated with another recorded parameter, and/or
provides information on the configuration voltage, the configuration current, the configuration temperature, the integrity of the converter configuration, the release of a substance from the converter configuration, the presence of a foreign substance, particularly from the surroundings of the converter configuration, and/or the charging state, and/or
suggests a conversion of the converter configuration into another operating state.

In a preferred embodiment the battery exhibits a display device. The display device is provided to display the second state of the functional device in particular and/or to transmit corresponding information, particularly to a battery control or an independent control. This embodiment offers the advantage that an individual can be provided with information on the state of the battery, the converter configuration or the functional device.

The display device is particularly preferably configured as: a beeper, a light-emitting diode, an infrared interface, a GPS device, a GSM subassembly, a first near-field radio device or a transponder.

In a preferred embodiment, the battery exhibits a battery control device. The battery control device is provided to control the battery or the converter configuration. Particularly preferably, the battery control device is provided to process a signal from one of these measuring sensors and/or to activate one of these circuit breakers.

In a preferred embodiment, a current of at least 50 A, further preferably of at least 100 A, further preferably of at least 200 A, further preferably of at least 500 A, further preferably of at least 1000 A can be drawn from at least one of these energy converters. This embodiment offers the advantage of an improved performance of the consumer supplied by the energy converter.

In a preferred embodiment, at least one of these energy converters may supply a voltage, particularly a terminal voltage, of at least 1.2 V, further preferably of at least 1.5 V, further preferably of at least 2 V, further preferably of at least 2.5 V, further preferably of at least 3 V, further preferably of at least 3.5 V, further preferably of at least 4 V, further preferably of at least 4.5 V, further preferably of at least 5 V, further preferably of at least 5.5 V, further preferably of at least 6 V, further preferably of at least 6.5 V, further preferably of at least 7 V, further preferably of at least 7.5 V. The energy converter preferably comprises lithium or lithium ions. This embodiment offers the advantage of an improved energy density of the energy converter.

In a preferred embodiment, at least one of these energy converters may be operated at between −40° C. and 100° C., further preferably at between −20° C. and 80° C., further preferably at between −10° C. and 60° C., further preferably at between 0° C. and 40° C. This embodiment offers the advantage of the most unrestricted installation or use possible of the energy converter for supplying a consumer, particularly a motor vehicle or a stationary plant or machine.

In a preferred embodiment, at least one of these energy converters exhibits a charging capacity of at least 3 ampere-hours [Ah], further preferably of at least 5 Ah, further preferably of at least 10 Ah, further preferably of at least 20 Ah, further preferably of at least 50 Ah, further preferably of at least 100 Ah, further preferably of at least 200 Ah, further preferably of at least 500 Ah. This embodiment offers the advantage of an improved operating duration of the consumer supplied by the energy converter.

In a preferred embodiment, at least one of these energy converters exhibits a gravimetric energy density of at least 50 Wh/kG, further preferably of at least 100 Wh/kG, further preferably of at least 200 Wh/kG, further preferably of at least 500 Wh/kG. The energy converter preferably exhibits lithium or lithium ions. This embodiment offers the advantage of an improved energy density of the energy converter.

In a preferred embodiment, the battery exhibits a first circuit node. This circuit node serves to provide the electrical connection between a plurality of components or subassemblies of the battery. Emanating from this circuit node are:

a first series connection comprising one of these circuit breakers and the battery connection of first polarity, wherein the circuit breaker is disposed closer to the circuit node, wherein the current path between the circuit node and the battery connection of first polarity is interrupted when the circuit breaker is activated;
a second series connection comprising at least one of these functional devices and one of these discharge resistors;
an incoming line to this converter configuration, particularly to the configuration connector of first polarity.

If the current path between this circuit node and the battery connection of first polarity is interrupted when the circuit breaker is activated, particularly in the second state of the functional device, then the configuration voltage is not present at the battery connections. The converter configuration should not be able to release any energy when the circuit breaker is activated.

The second series-connection is preferably electrically connected to the configuration connector of second polarity in such a manner that a circuit is formed at least temporarily from the converter configuration, this discharge resistor and this functional device, particularly preferably in the second state.

The configuration connector of second polarity is preferably electrically connected to the battery connection of second polarity. In this case, the configuration voltage of the converter configuration is present at least temporarily at the battery connectors of different polarity, particularly when the circuit breaker is not activated.

Particularly when a foreign body from the battery surroundings acts on the converter configuration of said battery or at least on one of its energy converters or penetrates the latter, for example in the event of an accident, particularly a motoring accident, said energy converter may be damaged. If the functional device has assumed its second state and the converter configuration has drawn energy, the configuration voltage may be uncoupled from the battery connectors by means of the circuit breaker. This preferred embodiment offers the advantage of greater reliability, particularly for rescue workers where the associated motor vehicle has been involved in an accident.

A preferred embodiment of the battery exhibits this converter configuration having two of these configuration connectors of different polarity. The battery further exhibits two of these battery connectors of different polarity, wherein the configuration voltage of the converter configuration is present at least temporarily at these battery connectors of different polarity. The configuration connector of second polarity is preferably electrically connected to the battery connector of second polarity, wherein the configuration voltage of the converter configuration is present at least temporarily at the battery connectors. The battery further exhibits the first series connection comprising one of these circuit breakers and the battery connector of first polarity, wherein the circuit breaker is disposed closer to the circuit node. Furthermore, the battery exhibits the second series connection of at least one of these functional devices and one of these discharge resistors. The second series connection is preferably electrically connected to the configuration connector of second polarity, such that a circuit made up of the converter configuration, this discharge resistor and this functional device is formed at least temporarily, particularly preferably in the second state of the functional device. The battery further exhibits the second circuit node. The battery preferably exhibits at least one of these measuring sensors, this battery control device and/or one of these display devices.

In this embodiment, this discharge resistor restricts or controls the energy drawn from the converter configuration in the second state of this functional device. By means of the circuit breaker, the configuration voltage may be uncoupled from the battery connectors. This preferred embodiment offers the advantage of greater battery reliability.

According to a preferred development of this embodiment, the battery exhibits a parallel circuit of at least two or a plurality of these functional devices. This plurality of functional devices is disposed adjacent to different wall sections of the converter configuration. This means that the second current path for reducing the energy stored in the battery or in the converter configuration is formed as soon as only one of the functional devices is converted into its second state. The battery preferably exhibits two, four or six of these functional devices, wherein two of these functional devices in each case are disposed adjacent to opposite, particularly parallel, wall sections. This preferred development offers the advantage that the battery's reliability is increased independently of the location where the foreign body acts on the battery.

According to a further preferred development of this embodiment, the battery exhibits this battery control device, at least one of these measuring sensors, at least one of these display devices and a bridging device of this functional device activated by the battery control device. The bridging device is used to provide a current path at least in part, which enables energy to be drawn from the converter configuration via this discharge resistor. The bridging device exhibits a switch which is electrically connected in parallel to the functional device. The battery control device is signal-connected to this measuring sensor, this display device, this circuit breaker and the switch of this bridging device. The battery control device is configured to close the switch of the bridging device, particularly when the signal from one of these measuring sensors is indicative of an unwanted operating state of the converter configuration. The battery control device is particularly designed to activate the display device at the same time as closing the switch of the bridging device. The measuring sensor is preferably designed as a temperature sensor, particularly for the temperature of the converter configuration, as a voltage sensor, particularly for the configuration voltage, or as an acceleration sensor, for an acceleration to which the battery or the converter configuration thereof is exposed. With this development, energy can be drawn from the converter configuration, particularly in the case of an accident, particularly one involving a motor vehicle, even when there is no mechanical damage to the battery by a foreign body. This preferred development offers the advantage of greater operating reliability of the battery, particularly for rescue workers if the associated vehicle is involved in an accident.

The method described below for operating the battery according to the invention, or one of its preferred embodiments, variants or developments, is particularly used to transferthe functional device into the second state. The method is characterized by:
(S1) penetratingof at least one of these functional devices by the foreign body not associated with the battery and/or
(S2) electrical connecting of the first potential region to the second potential region, particularly by the foreign body not associated with the battery.

If a foreign body penetrates the functional device and thereby damages the insulating region, the potential regions adjacent to the insulating region with different polarity come into electrical contact. A current path is closed, which electrically connects to one another indirectly, i.e. via the potential regions of different polarity, at least two of these electrodes of different polarity. Via this current path, electrical energy or a discharge current may be drawn from the converter configuration. The electrically conductive potential regions R_{P1}, R_{P2} and, in particular, the electrical contact resistance R_{K} between these potential regions of different polarity form an aggregate resistance R_{G}. This aggregate resistance R_{G} acts against the discharge current. In this case, the contact resistance R_{K} may be considerably greater than the resistances of the potential regions R_{P1}, R_{P2}. If the contact resistance R_{K} accounts for the largest proportion of aggregate resistance R_{G}, the electrical energy drawn from the converter configuration is converted into thermal energy there for the most part. In this case, the electrically and also thermally conductive potential regions are used to distribute the thermal energy. This preferred embodiment offers the advantage of greater battery reliability during the operation thereof, particularly within a motor vehicle.

A preferred embodiment of the method is particularly used to transferthe battery into a third state, particularly from the second state of the functional device. This embodiment is characterized by:
(S3) drawing of an electrical current from the converter configuration, particularly during a predetermined first interval of time, particularly via the discharge resistor.

Following S3, particularly subsequent to the first time interval, the converter configuration is converted into the third state. This third state is characterized in that the converter configuration exhibits a smaller predetermined residual battery voltage compared with the battery voltage. The battery control device preferably monitors step S3. An LED preferably indicates that a conversion of the converter configuration into the third state has been initiated or has taken place.

The predetermined first interval of time is preferably at least 10 s, further preferably 20 s, further preferably 50 s, further preferably 100 s, further preferably 200 s, further preferably 1000 s, further preferably 1 h.

According to a first preferred embodiment of this method, the third state is defined by means of the predetermined residual battery charge. The predetermined residual battery voltage in this case is maximum 90% of the battery's rated voltage or the maximum battery charge, further preferably maximum 80%, further preferably maximum 70%, further preferably maximum 60%, further preferably maximum 50%, further preferably maximum 40%, further preferably maximum 30%, further preferably maximum 20%, further preferably minimum 5%.

According to a further preferred embodiment of this method, the third state is defined by means of the predetermined residual voltage of at least one of these energy converters. In this case, the predetermined residual voltage is a maximum of 3.5 V, further preferably a maximum of 3 V, further preferably a maximum of 2.8 V, further preferably a maximum of 2.6 V, further preferably a maximum of 2.4 V, further preferably a maximum of 2.2 V, further preferably a maximum of 2 V, further preferably a maximum of 1.5 V, further preferably a maximum of 1.2 V, further preferably a maximum of 1 V, further preferably a maximum of 0.5 V, further preferably a minimum of 0.2 V.

The method according to the invention offers the advantage that the energy delivered by the converter configuration is limited or checked by the electrical resistor of the functional device, preferably by the discharge resistor. The method according to the invention offers the advantage that the energy delivered from the converter configuration is checked, even if only the functional device is damaged by the foreign body. The method according to the invention offers the advantage that the energy stored in the converter configuration can be reduced via the functional device, which is connected in parallel and electrically conductive in the second state, particularly when the foreign body has penetrated both the functional device and also the converter configuration, particularly when the foreign body has deformed the functional device. The operating reliability of the converter configuration and with it the operating reliability of the primary battery is therefore increased.

A battery which is designed with one of these discharge resistors and an LED is particularly suitable for operation according to this second method. This preferred embodiment offers the advantage that the energy delivery from the converter configuration is limited or checked by the electrical resistance of the discharge resistor. This preferred embodiment offers the advantage that it is evident from the surroundings whether the functional device is to be converted or has been converted into the second state.

A further preferred embodiment of the method is particularly used to uncouple the configuration voltage from the battery connectors. This preferred embodiment is characterized by:
(S4) Activating of the circuit breaker, particularly by means of the battery control device, whereupon in particular the electrical connection between one of these battery connectors (3a), particularly of first polarity, and one of these configuration connectors (6a) of the same polarity is interrupted.

This circuit breaker is connected between one of these configuration connectors and one of these battery connectors of the same polarity, preferably between the configuration connector of first polarity and the battery connector of first polarity or between the configuration connector of second polarity and the battery connector of second polarity. Following activation of the circuit breaker, the electrical connection between the configuration connector connected to the circuit breaker and the battery connector is interrupted. Consequently, the configuration voltage is uncoupled from the battery connectors, particularly after S4. This preferred embodiment offers the advantage of greater battery reliability, particularly even following the harmful action of a foreign body.

Further advantages, features and possible applications of the present invention result from the following description in conjunction with the figures. In the figures

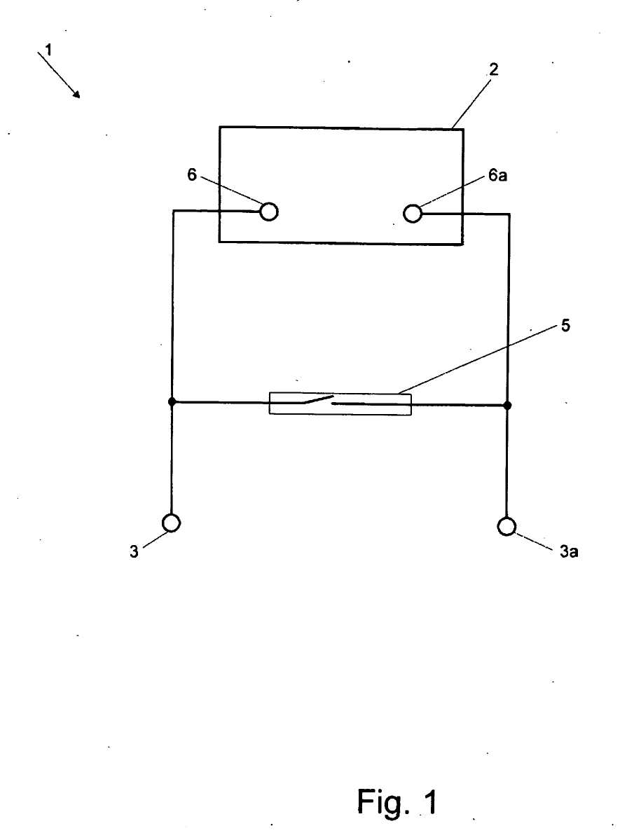

FIG. 1 shows in schematic form a battery according to the main claim,

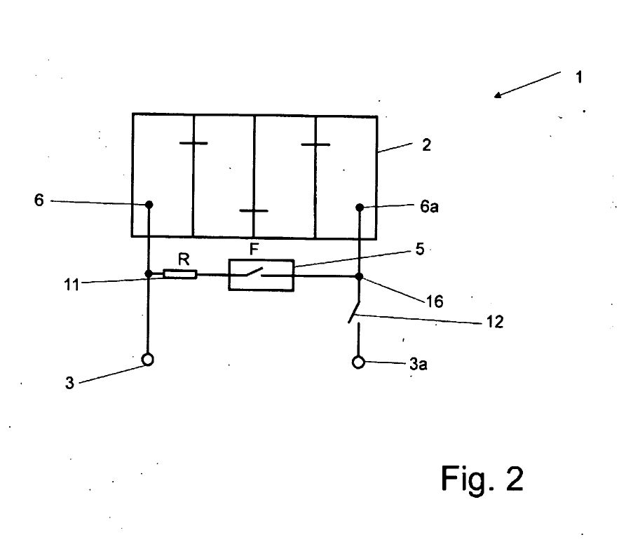

FIG. 2 shows in schematic form a second exemplary embodiment of the battery with the discharge resistor and circuit breaker,

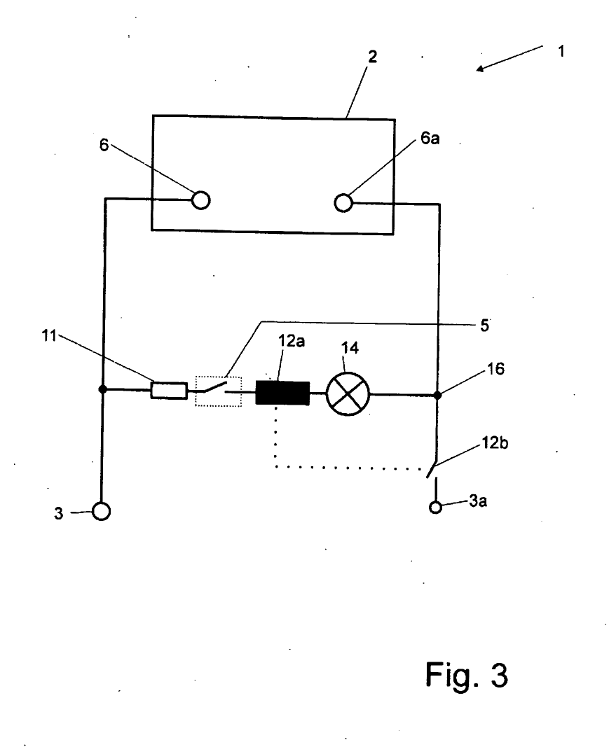

FIG. 3 shows in schematic form a third exemplary embodiment of the battery with the discharge resistor, special circuit breaker and display device and the first circuit node,

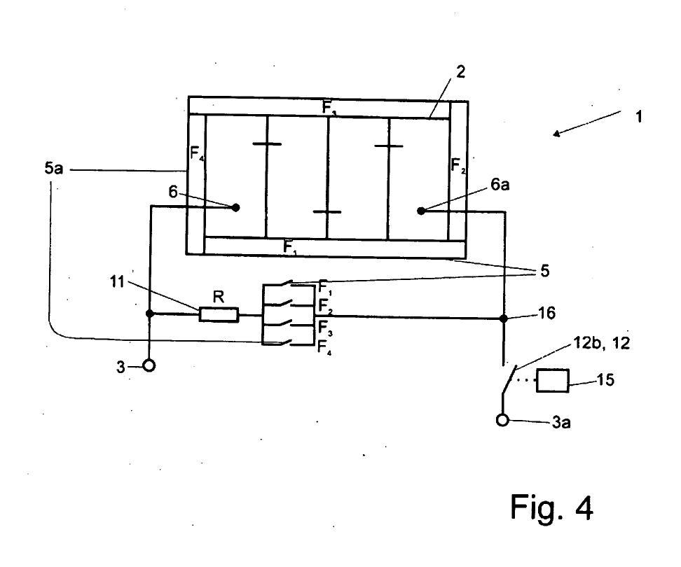

FIG. 4 shows in schematic form a further exemplary embodiment of the battery with four functional devices, the discharge resistor, circuit breaker, battery control device and first circuit node,

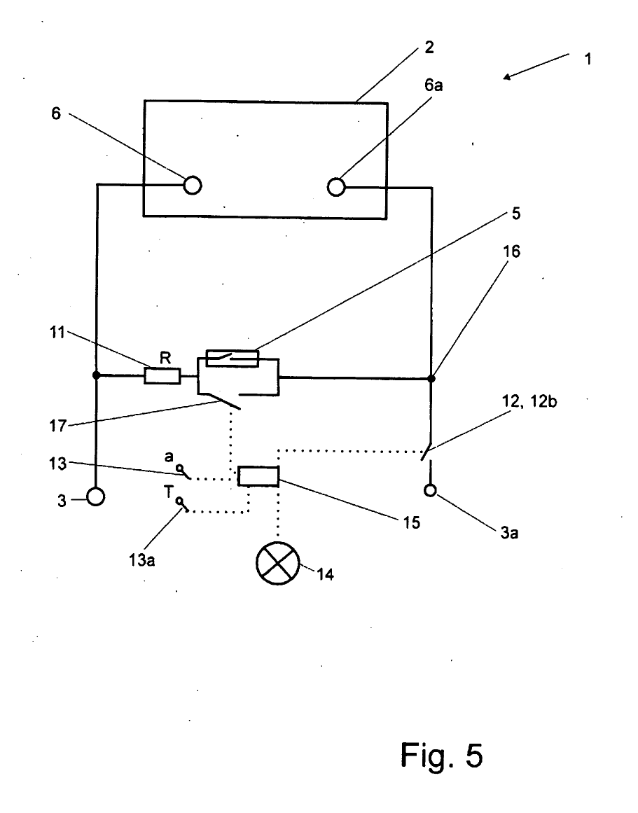

FIG. 5 shows in schematic form a fifth exemplary embodiment of the battery with the discharge resistor, circuit breaker, battery control device, measuring sensors, first connection node with bridging device.

FIG. 1 shows in schematic form a battery 1 according to the main claim. The battery 1 is designed with this converter configuration 2, two of these battery connectors 3, 3a and a functional device 5. The representation does not show that the functional device 5 is disposed adjacent to one of these wall sections of the converter configuration 2. Unlike in FIG. 4, neither does it show that a plurality of these functional devices are arranged adjacent to one of these wall sections in each case and preferably substantially completely cover these wall sections in each case.

The converter configuration 2 exhibits at least two electrochemical energy converters in series connection and two configuration connectors 6, 6a of different polarity. Battery connectors 3, 3a are connected to the configuration connectors 6, 6a, in the present case by means of two busbars of different polarity. The functional device 5 is electrically connected to the configuration connectors 6, 6a of different polarity, likewise by means of these busbars in the present case. If the functional device 5 is converted into its second state, the configuration connectors 6, 6a of different polarity are connected to one another. An electrical current then flows through the functional device 5, which reduces the energy contained in the converter configuration 2. In this case, the resistance of the functional device 5 limits this electrical current.

FIG. 2 shows in schematic form the second exemplary embodiment of the battery 1 with the discharge resistor and the circuit breaker 12. Only the substantial differences as compared with the battery according to FIG. 1 are set out below.

The discharge resistor 11 is connected between the functional device 5 and one of these configuration connectors 6. The battery 1 exhibits this first circuit node 16. An incoming line to the functional device 5, an incoming line to the configuration connector 6a of first polarity and an incoming line to the circuit breaker 12 emanate from the circuit node 16. The circuit breaker 12 is connected between the battery connector 3a of first polarity and the circuit node 16 and is designed as a switch. When the functional device 5 is converted into its second state, the configuration connectors 6, 6a of different polarity are connected to one another. An electrical current then flows through the functional device 5 and also the discharge resistor 11. In this case, the series connection of the resistors from the functional device 5 and the discharge resistor 11 restricts this electrical current. When the circuit breaker 12 is activated, the electrical connection between the configuration connector 6a of first polarity and the battery connector 3a of first polarity is interrupted. Consequently, the configuration voltage is not present at the battery connectors 3, 3a. This design offers the advantage of greater battery reliability, particularly during operation thereof within a motor vehicle.

FIG. 3 shows in schematic form the third exemplary embodiment of the battery 1 with the discharge resistor 11, particularly the circuit breaker 12 and the display device 14. Only the substantial differences compared with the battery according to FIG. 2 are set out below.

The circuit breaker 12 exhibits a relay 12a and a spring-loaded switch 12b. The coil of the relay is electrically connected between the functional device 5 and the first circuit node 16. When current flows through the coil of the relay 12a, the relay 12a opens the switch 12b. The display device 14 is designed as a lamp and is likewise connected between the functional device 5 and the first circuit node 16. When the functional device 5 is converted into its second state, the configuration connectors 6, 6a of different polarity are connected to one another. A discharged electrical current or discharge current then flows through the functional device 5, the display device 14, through the coil of the relay 12a and also the discharge resistor 11. The coil of the relay 12a opens the switch 12b. The electrical connection between the configuration connector 6a of first polarity and the battery connector 3a of first polarity is then interrupted. The configuration voltage is not present at the battery connectors 3, 3a in the present case for as long as a discharge current of sufficient intensity flows through the coil of the relay 12a. If the discharge current falls below a minimum value, the spring-loaded switch 12 b closes, so that the configuration voltage is once again present at the battery connectors 3, 3a. The residual battery voltage can then be measured. This design offers the advantage of greater battery reliability, particularly during operation thereof in a motor vehicle.

FIG. 4 shows in schematic form the fourth exemplary embodiment of the battery 1 with four of these functional devices 5, 5a, the discharge resistor 11, circuit breaker 12, battery control device 15 and first circuit node 6. Only the substantial differences as compared with the battery according to FIG. 2 or FIG. 3 are set out below.

These four functional devices 5, 5a, also referred to as F₁, F₂, F₃ and F₄, are connected to one another in parallel. These functional devices F₁, F₂, F₃ and F₄ are disposed adjacent to a variety of these wall sections of the converter configuration 2. These functional devices advantageously cover these wall sections substantially completely in each case. The reliability of the battery 1 according to this embodiment is thereby improved largely independently of the location of the influence of the foreign body. In this case, the circuit breaker is activated by the battery control device 15. This design offers the advantage of greater battery reliability, particularly during operation thereof in a motor vehicle.

FIG. 5 shows in schematic form the fifth exemplary embodiment of the battery 1 with the discharge resistor 11, the circuit breaker 12, the battery control device 12, two measuring sensors 13, 13a, the first circuit node 16 with a bridging device 17. Only the substantial differences compared with the previous exemplary embodiments of the battery are set out below.

These measuring sensors 13, 13a are configured as acceleration sensors for an acceleration to which the converter configuration 2 is exposed and as temperature sensors for the temperature of one of these wall sections of the converter configuration 2. The bridging device 17 is designed with a switch. The bridging device 17 is connected in parallel to the functional device 5. When the switch of the bridging device 17 is closed, a discharge current can flow through the discharge resistor 11.

The battery control device 15 is designed to receive and process signals from these two measuring sensors 13, 13a. The battery control device 15 is further designed to activate the circuit breaker 12, the display device 14 and the bridging device 17, particularly the switches thereof. The signal lines are depicted as dotted lines. Furthermore, the battery control device 15 is designed to activate the circuit breaker 12, the display device 14 and/or the bridging mechanism 17, depending on a signal from these measuring sensors 13, 13a.

If one of these measuring sensors 13, 13a indicates an unwanted operating state of the converter configuration 2 following receipt or processing by the battery control device 15, the battery control device 15 can transmit at least one of the following commands:
closure of the bridging device 17, particularly closure of the associated switch,
opening of the circuit breaker 12, and/or
connection of the display device 14, particularly to indicate the second state of the functional device 5, particularly to indicate an unwanted operating state.

This embodiment offers the advantage of greater battery reliability, particularly during operation thereof in a motor vehicle.

### REFERENCE LIST

1 Battery
2 Converter configuration
3, 3a Battery connector
4, 4a Wall section
5, 5a Functional device
6, 6a Configuration connector
7 Insulating region
7a, 7b Potential regions
8 Puncture-resistant layer
9, 9a Electrical conductors
10 Recess
11 Discharge resistor
12, 12a, 12b Circuit breaker
13, 13a Measuring sensor
14 Display device
15 Battery control device
16 First circuit node
17 Bridging device

1. A battery, comprising:
a converter unit including
at least two electrochemical energy converters and configured to convert chemical energy into electrical energy and to supply the electrical energy to a consumer, wherein the energy converters are electrically interconnected connected to one another, and
two configuration connectors of different polarity at which a configuration voltage is present, wherein the configuration voltage corresponds to the electrical voltage of the converter unit;
two battery connectors of different polarity and configured to make an electrical connection to the consumer (31), the two battery connectors being electrically connected to the configuration connectors;
at least one device configured to be connected to the configuration connectors of different polarity, the device being convertible from a first state into a second state, wherein in the first state, the configuration connectors of different polarity connected to the device are electrically insulated from one another and in the second state the configuration connectors are electrically connected to one another,
wherein the device includes a predetermined electrical resistance the converter unit includes at least one wall section, which is provided to delimit the converter unit, and the device covers the wall section at least in areas, and at least one of the energy converters is configured to store electrochemical energy and to convert supplied electrical energy into chemical energy and store the chemical energy.

2. The battery according to claim 1, wherein the at least one device includes:
a first potential region electrically connected at least indirectly to a configuration connector of a first polarity,
a second potential region electrically connected at least indirectly to a configuration connector of a second polarity,
an insulating region disposed between the first potential region and the second potential region and to electrically insulate the first and second potential regions from one another,
wherein in the second state the first potential region and the second potential region are electrically connected to one another.

3. The battery according to claim 2, wherein
one of first and second potential regions is a puncture-resistant layer, and
one of the first and second potential regions includes at least one electrical conductor, wherein the electrical conductor faces the insulating region, and the electrical conductor is electrically connected to one of the configuration connectors at least indirectly,
the insulating region includes at least one recess, wherein the at least one recess forms an electrical contact between the first potential region and the second potential region.

4. The battery according to claim 1, further comprising at least one of:
a discharge resistor connected between one of the first and second potential regions and one of the configuration connectors, the discharge resistor being configured to convert electrical energy into thermal energy, said resistor being thermally connected to one of the wall sections;
a circuit breaker connected between one of the configuration connectors and one of the battery connectors;
a measuring sensor configured to record an operating parameter of the battery and which provides a signal to a battery control device;
a display device configured to display the second state of the device; and
the battery control device is configured to control the battery or the converter unit based on the signal from the measuring sensor and to activate the circuit breaker.

5. The battery according to claim 1, wherein at least one of the energy converters
is configured to deliver a current of at least 50 A,
is configured to supply a voltage of at least 3.5 V,
is configured to be operated within an operating temperature range of −40° C. to +100° C.,
includes a charging capacity of at least 3 Ah, and
includes a gravimetric energy density of at least 50 Wh/kg.

6. The battery according to claim 1, further comprising a first circuit node that includes at least one of
a first series connection comprising a circuit breaker and the battery connection of first polarity, wherein the circuit breaker is disposed adjacent to the circuit node,
a second series connection comprising at least one device and a discharge resistor; and
an incoming line to the converter unit,
wherein the second series connection is electrically connected to the configuration connector of second polarity, such that a circuit including the converter unit, the discharge resistor and the device is formed in the second state, and
wherein the configuration connector of the second polarity is electrically connected to the battery connector of the second polarity and the configuration voltage of the converter unit is present at the battery connectors.

7. The battery according to claim 6, wherein the battery includes:
the converter unit including the two configuration connectors of different polarity, wherein the configuration voltage is present at these configuration connectors,
two battery connectors of different polarity, wherein the configuration voltage of the converter unit is present at the battery connectors of different polarity, wherein the configuration connector of second a polarity is electrically connected to the battery connector of a second polarity and wherein the configuration voltage of the converter unit is present at the battery connectors,
the first series connection comprising a circuit breaker and the battery connector of the first polarity, wherein the circuit breaker is disposed adjacent to the circuit node,
the second series connection comprising a device and a discharge resistor, wherein the second series connection is electrically connected to the configuration connector of the second polarity, such that a circuit including the converter unit, the discharge resistor and the device is formed in the second state,
the first circuit node, and
one of a measuring sensor, a battery control device or a display device.

8. A method of operating a battery according to claim 2, to transfer the device into a second state, comprising:
penetrating the device by a foreign body not associated with the battery; and
electrically connecting the first potential region to the second potential region.

9. The method according to claim 8, further comprising:
transferring the device into a third state from the second state by drawing an electrical current from the converter unit during a predetermined first interval of time, via the discharge resistor,
wherein in the third state, the battery includes a smaller predetermined residual battery voltage compared with battery voltages in the first and second states.

10. The method according to claim 9, further comprising:
uncoupling the configuration voltage from the battery connectors by activating a circuit breaker via a battery control device,
wherein an electrical connection between one of the battery connectors and the configuration connector of a same polarity is interrupted.

11. The battery according to claim 1, wherein the energy converters are electrically interconnected in series.

12. The battery according to claim 1, wherein the device is indirectly connected to the configuration connectors.

13. The battery according to claim 2, wherein the foreign body is not associated with the battery and the foreign body is electrically conductive.

14. The battery according to claim 3, wherein the potential region is a puncture-resistant layer.

15. The battery according to claim 4, wherein the measuring sensor is a temperature sensor.

16. The battery according to claim 4, wherein the measuring sensor is an acceleration sensor.

17. The battery according to claim 5, wherein at least one of the energy converters is configured to deliver a current of at least 100 A.

18. The battery according to claim 5, wherein at least one of the energy converters is includes a charging capacity of at least 10 Ah.

19. The battery according to claim 6, wherein the incoming line is connected to the configuration connector of the first polarity.

20. The method according to claim 8, wherein the foreign body is not associated with the battery.
